(19) United States
(12) Patent Application Publication
(10) Pub. No.: US 2003/0035637 A1
(43) Pub. Date: Feb. 20, 2003

(54) Optical network delay mechanisms

(76) Inventor: Richard E. Epworth, Herts (GB)

Correspondence Address: William M. Lee, Jr., LEE, MANN, SMITH, MCWILLIAMS, SWEENEY & OHLSON, P.O. Box 2786, Chicago, IL, 60690-2786, US

(21) Appl. No.: 09/750,872

(22) Filed: Dec. 28, 2000

(51) Int. Cl. G02B 6/16

(52) U.S. Cl. 385/123; 385/126

(57) ABSTRACT

An optical signal delay mechanism having a cladding material and a signal conducting core embedded for protection in the cladding material. The core has a longitudinal direction which is the direction of propagation of the optical signal and a transverse direction which is a direction substantially perpendicular to the direction of propagation of the optical signal. The embedding of the core is such that longitudinally spaced apart core sections are transversely separated by a continuous region of cladding material. This provides a more compact, robust and cheaper alternative to known delay mechanisms.

### TECHNICAL FIELD

The invention relates to optical communications networks, especially packet switched optical communications networks, and in particular to mechanisms for avoiding collisions of communications traffic in such networks.

### BACKGROUND OF THE INVENTION

A communications network typically comprises a series of nodes interconnected in a manner which makes for most efficient routing of communications traffic from one node to another. Each node rally has more than one connection, each to another node in the network. A switch at the node routes traffic between the various connections. In the case of an optical network, the connections may be made by one or more optical fibres, and traffic may be in the form of modulated optical signals.

In a packet switched network, information, such as website page content, is transported around the network in the form of packets. That is to say, the information is broken down into packets or bursts at or close to the point of entry into the network, which are individually transported around the network and reassembled at their destination. In order to avoid the collision of packets arriving simultaneously at any node along different connections, it may be necessary to provide some form of buffer or delay mechanism. The packets arriving on one connection may be held in the delay mechanism until such time as their continued progress would not result in collision.

In the electrical domain, buffering packets is, with technology now available, relatively straightforward. However, in the optical domain, storage is more problematic.

An optical fibre typically comprises a core, which serves as the optical signal conducting pathway, and a cladding which provides protection for the core against environmental effects and mechanical forces. If the core were not protected by the cladding, micro-cracks in its surface could be penetrated by air and water, with a resultant detrimental effect on the performance of the fibre. Further mechanical protection may be provided by means of a coating, for example a plastics material sleeve. In terms of the overall volume of the fibre, the coatings tend to occupy a substantial proportion and contribute significantly to cost. In addition, all optical fibres have to be subjected to a testing routine prior to use, during which they are strained so as to ensure that they can withstand the strains and flexing likely to be experienced in use. Also, the use conditions, such as, for instance, all the different radii of curvature through which a fibre may be bent in following a tortuous path underground, places constraints on design processes.

One known delay mechanism for optical networks is provided by additional lengths of optical fibre close to a node, commonly known as delay line. These are usually constituted by coils of transmission fibre. Some form of “intelligence” is also provided close to the node which detects that a collision is imminent and, in response, diverts some of the packets along the additional length of fibre. In effect, the packets are made to travel the additional distance so that by the time they emerge from the mechanism, the other potentially colliding packets have passed. However, such an arrangement tends to require relatively long lengths of transmission fibre. These are generally coiled around a spool, but still occupy considerable space and, in order to maintain a good quality signal, need to be low loss. Long, low loss fibres can be difficult and expensive. Alternatively, the diverted optical signal may require amplification which adds complexity and cost. In addition, multiple delay values may only be achieved by multiple passes of the diverted optical signal or multiple lengths of fibre.

An alternative, electrical domain, solution is to use electronic mechanisms at the periphery of the network. However, this requires high capacity network links.

### OBJECT OF THE INVENTION

An object of the invention is to provide a delay mechanism for use in an optical communications network, in particular for use in avoiding packet collisions, which overcomes the disadvantages of the prior art mechanisms.

### SUMMARY OF THFE INVENTON

According to a first aspect, the invention provides an optical signal delay mechanism comprising a cladding material, a signal conducting core embedded for protection in the cladding material, which core has a longitudinal direction being the direction of propagation of the optical signal and a transverse direction being a direction substantially perpendicular to the direction of propagation of the optical signal, wherein the embedding of the core is such that longitudinally spaced apart core sections are transversely separated by a continuous region of cladding material.

In its broadest terms, the delay mechanism according to the first aspect of the invention provides a more compact, robust and cheaper alternative to prior art mechanisms. The core in effect “shares” cladding material, that is to say, it is embedded in the cladding material in such a fashion that adjacent longitudinally spaced apart core sections utilise the same region of cladding material. Such an arrangement has an advantage that it eliminates the need for a coating of the type found on a conventional transmission fibre. Thus, in comparison to a coiled transmission fibre used as a delay mechanism, volume requirements are reduced. Reducing volumes is of particular value in view of the space constraints now being placed upon the equipment housings at nodes, in which delay mechanisms are most likely incorporated. Also, it is advantageous to maximise the delay available from a given volume. In addition, the embedding eliminates the need to protect the core along the whole of its length against environmental attack, for instance from air and water. Moreover, because the fibre is embedded it can not be subjected to the sorts of strains or flexing to which a standard transmission fibre is subject when it is, for example, laid underground. Thus, there is no need to put the core through a strain or similar test procedure prior to use.

The invention may further comprise a support for holding the cladding material and the embedded core. For instance the support could be in the form of a spool. The core may follow a substantially helical path around the hub of the spool or may follow a layered substantially helical path, with one helix of core overlaying another, in the manner of a hosepipe coiled around a reel. Such an arrangement has the advantage that the radius of curvature of the core is more or less constant which means that there are less constraints on core design.

The mechanism may comprise more than one core each embedded in the same cladding material such that it may provide multiple delay paths.

Each core may further have an entry end and an exit end which extend out of the cladding material. The entry and exit ends may be each connected to a switch for incorporation into an optical connection thereby to enable signals to be diverted through the mechanism. The switch may be activated under the control of node processing circuitry included in which may be a detector of imminent collisions.

A further advantage is that the continuous cladding material, which also includes a dopant, facilitates amplification of the delayed optical signal by pumping. In particular, multiple low power laser light pump sources may be used in an evanescent mode of operation.

Preferably, the mechanism according to a first aspect of the invention is made by forming an optical fibre having a core and a cladding, winding the fibre on to a support and fusing the cladding material such that longitudinally spaced apart core sections arc transversely separated by a continuous region of cladding material. The cladding may be applied to the core after the core is drawn out or by use of a core/cladding preform with a low softening point cladding material. The type of material conventionally used for transmission fibre cladding or a low melting point glass make suitable cladding material. The cladding may be constituted by more than one layer of cladding material so as to facilitate the use of an external layer material which may be particularly adapted to fusing but which would, if it were the only layer, possibly compromise optical performance. A good optically performing material may be used as the internal layer.

According to a second aspect, the invention provides a method of forming a mechanism according to a first aspect of the invention.

According to a third aspect, the invention provides an optical signal delay mechanism comprising a coiled optical signal conducting core embedded in a body of cladding material.

According to a fourth aspect, the invention provides an optical communications network incorporating a mechanism according to a first aspect or a third aspect of the invention.

According to a fifth aspect, the invention provides a node of an optical communications network incorporating a mechanism according to a first aspect or a third aspect of the invention.

According to a sixth aspect, the invention provides switching for an optical communications network incorporating a mechanism according to a first aspect or a third aspect of the invention.

### BRIEF DESCRIPTION OF THE DRAWINGS

FIG. 1 is a schematic illustration of a simplified optical communications network;

FIG. 2 is a schematic block diagram of one node of the network shown in FIG. 1;

FIG. 3 is a schematic illustration of an optical delay mechanism according to the invention;

FIG. 4 is a diametrical cross section of the cladding mechanism shown in FIG. 3; and,

FIG. 5 is a schematic drawing of an alternative optical fibre for use in a delay mechanism according to one aspect of the invention.

### DETAILED DESCRIPTION OF THE INVENTION

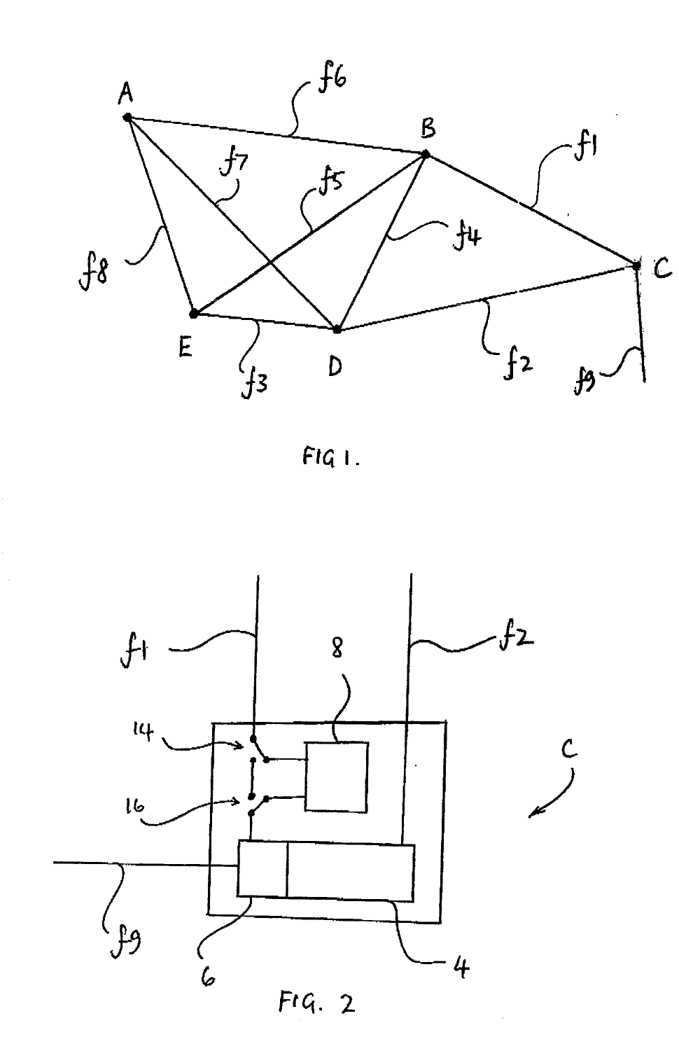

With reference to FIG. 1, a typical optical communications network indicated generally at 1 has five nodes A-E interconnected by optical fibres f1-f8. Information is transmitted from one node to another via intervening nodes at which it is appropriately routed. For instances information input into node C, destined for node E, may be routed, by switching, to node D, where it is routed, again by switching, to node E. Node C has a further optical fibre f9 which is a connection to another network.

The network 1 is an optical packet switched network in which information, in other words data, is transported around the network in the form of packets. As each node A-E has more than one connection, there is the opportunity for separate packets each arriving along a different connection, to collide at a node.

With further reference to FIG. 2, node C (selected by way of illustrating the invention) is the junction of connections f1, f2 and f9. At the node C, there is node processing circuitry 4 including the switching for routing traffic between the connections f1, f2 and f9. Also included within the processing circuitry 4 is a collision detector 6 which observes incoming packets and predicts collisions.

Taking, for example (again for the purposes of illustration only),connections f1 and f2 as incoming connections and connection f9 as the outgoing connection; collision avoidance is achieved by means of delay mechanism 8 which is selectively connected to connection f1 by optical switches 14, 16 incorporated in the connection f1. In the event that data packets incoming on connections f1 and f2 are predicted by the detector 6 as likely to collide at the node C, switches 14, 16 are actuated (as shown in FIG. 2) so as to divert the packets incoming on connection f1 through delay mechanism 8. This has the effect of buffering or delaying the progress of the diverted packets so that by the time they emerge from the mechanism 8 they are no longer on course for collision. Another way of viewing the operation of the mechanism is as a store of data, and its capacity being dictated by the volume of data which can occupy the core at any one time. A core 10 km long could, for instance, store in the region of 10⁶ bits of data.

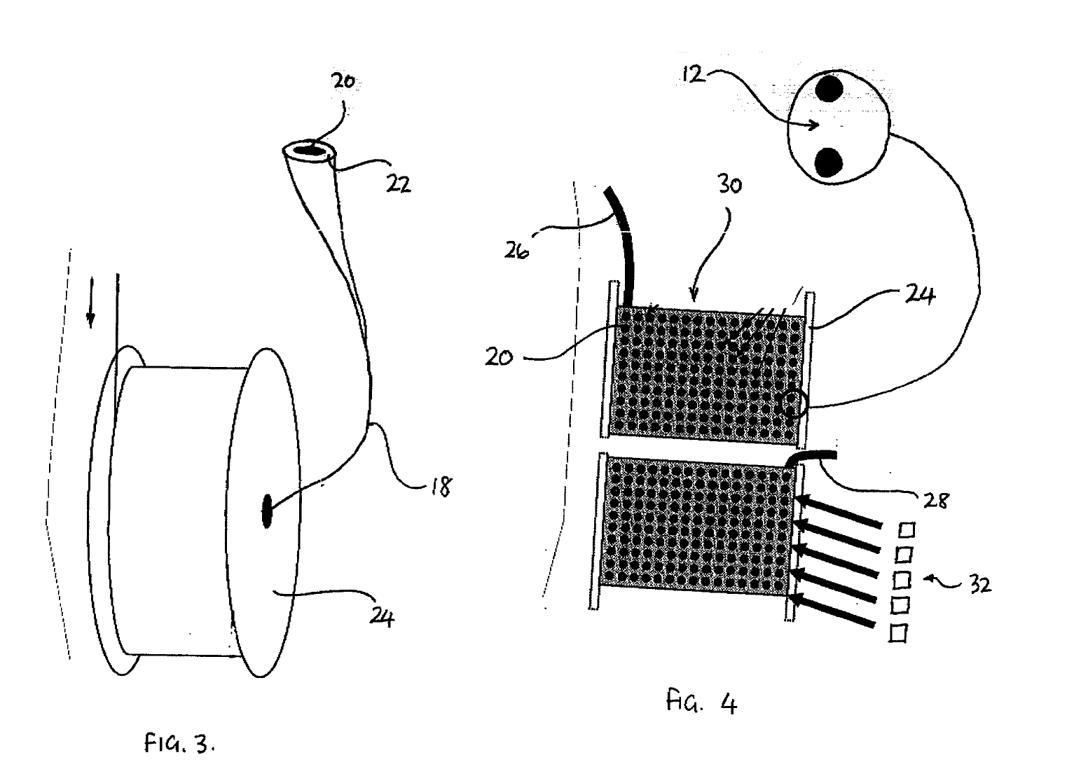

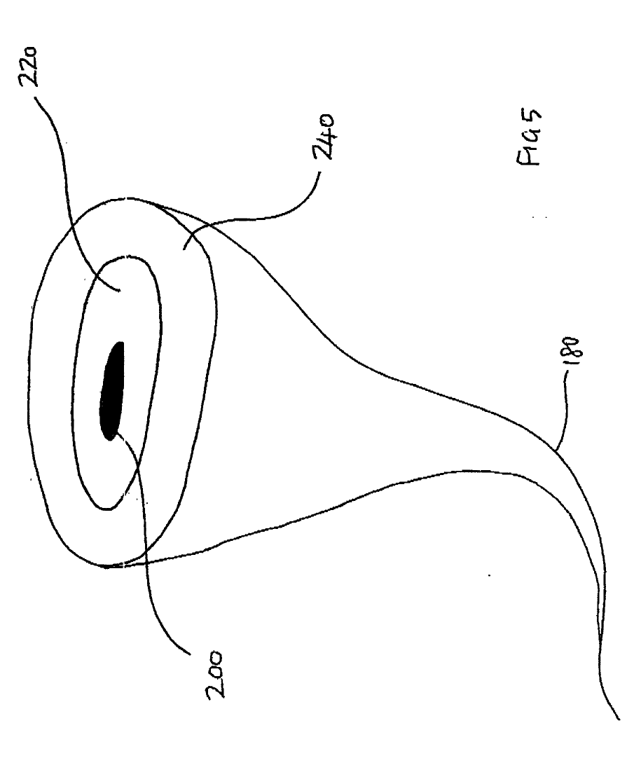

With reference to FIG. 3, delay mechanism 8 is made from a length of optical fibre 18 having a core 20 and a cladding 22 which is coiled around a spool 24. The fibre 18 is provided by applying the cladding 22 shortly after the core 20 is drawn out. The cladding 22 is a conventional optical fibre cladding material. After the fibre 18 has been wound on to the spool 24, the whole arrangement is heated so as to melt the cladding 22, which fuses so as to form a rigid, continuous body 30 of cladding material with the core 20 embedded in it (see FIG. 4), leaving only an entry end 26 and an exit end 28 extending from the core. These are connected to the switches 14, 16 respectively. The body 30 is continuous in the sense that there are no discontinuities or boundaries as is the ease when separately formed fibres lay adjacent one another following coiling on to a reel.

The fibre 18 is coiled around the spool 24 in layers. The fibre is wound from left to right or right to left until one layer is complete, and then another layer is built up over the top, again by winding from one side to the other, such that longitudinally spaced apart sections of the fibre 18 (the longitudinal direction being the direction of propagation of the optical signal) either overlie, underlie or lie adjacent other section of fibre 18. The core 20 in each layer follows a helical path so that the complete core 20 follows a layered helical path. When the cladding 22 is melted, longitudinally spaced apart sections of the core 20 are transversely being substantially perpendicular to the longitudinal direction) separated by a continuous region, as for example shown at 12 between the core sections 20a and 20b, of the cladding body 30. Hence, longitudinally spaced apart sections of the core 20 effectively share regions of the cladding material. An alternative way of viewing the mechanism 8 is as a coiled core 20 embedded in a body 30 of cladding material.

The continuous cladding body 30 facilitates the amplification of the signal diverted through the core 20. The principles of optical fibre amplification, which are well know, will not be discussed in detail here. In the present case, the embedded core 20 may be illuminated by multiple, low power laser pump lights sources 32 so as to flood the body 30 from which pump light is coupled into the core 20, appropriately doped. The pump light sources may be arranged so as to work either toward the entry end 26 or the exit end 28.

In use, packets destined for collision are diverted from connection f1, through the entry end 26, along the helical coiled core path and out through the exit end 28. The fused cladding material behaves optically in the same way as the cladding material of a conventional transmission fire, promoting total internal reflection.

With reference to FIG. 5, an alternative fibre 180 for use in a delay mechanism according to the invention has a core 200, and a cladding having a first, internal layer 220 and a second, external layer 240. The internal layer 220 is of an optically performing material and the outer layer 220 is of an easily fusible material, such as low melting point glass. When using such fibre for making a delay mechanism by winding the fibre 180 on to a spool, the core 200 and the internal layer 220 can, in effect, be considered as a “core”, in the sense that they together perform an optical function and it is only the outer layer 220 which fuses and becomes continuous.

1. An optical signal delay mechanism comprising a cladding material, a signal conducting core embedded for protection in the cladding material ,which core has a longitudinal direction being the direction of propagation of the optical signal and a transverse direction being a direction substantially perpendicular to the direction of propagation of the optical signal, wherein the embedding of the core is such that longitudinally spaced apart core sections are transversely separated by a continuous region of cladding material.

2. An optical signal delay mechanism according to claim 1 further comprising a support for holding the cladding material and the embedded core.

3. An optical signal delay mechanism according to claim 2 wherein the support is in the form of a spool having a hub.

4. An optical signal delay mechanism according to claim 3 wherein the core follows a substantially helical path around the hub or a substantially layered helical path around the hub.

5. An optical signal delay mechanism according to claim 1 comprising more than one core each embedded in the same cladding material.

6. An optical signal delay mechanism according to claim 1 wherein the core has an entry end and an exit end which extend out of the cladding material.

7. An optical signal delay mechanism according to claim 6 further provided with switching means for incorporation into an optical connection thereby to enable signals to be diverted through the core wherein the entry end and exit end are each connected to the switching means.

8. An optical signal delay mechanism according to claim 7 provided at or close to a node having node having processing circuitry means wherein the switch means is actuated under the control of node processing circuitry.

9. An optical signal delay mechanism according to claim 8 wherein the node processing circuitry has collision detection means.

10. An optical signal delay mechanism according to claim 1 comprising amplification means.

11. An optical signal delay mechanism according to claim 10 wherein the amplification means comprises a plurality of pumping sources.

12. An optical signal delay mechanism according to claim 1 made by forming an optical fibre having a core and a cladding, winding the fibre on to a support and fusing the cladding material.

13. A method of making an optical signal delay mechanism comprising forming an optical fibre having a core and a cladding, winding the fibre on to a support and fusing the cladding material such that longitudinally spaced apart core sections are transversely separated by a continuous region of cladding material.

14. A method of making an optical signal delay mechanism wherein the cladding is applied to the core shortly after the core is drawn out or wherein a core/cladding preform is used.

15. A method of making an optical signal delay mechanism according to claim 13 wherein the cladding material is a low melting point glass.

16. A method of making an optical signal delay mechanism according to claim 13 wherein the cladding is constituted by more than one layer of cladding material.

17. An optical signal delay mechanism comprising a coiled optical signal conducting core embedded in a body of cladding material.

18. An optical communications network incorporating an optical signal delay mechanism according to claim 1 or claim 17.

19. A node of an optical communications network incorporating all optical signal delay mechanism according to claim 1 or claim 17.

20. Switching for an optical communications network incorporating an optical signal delay mechanism according to claim 1 or claim 17.
